(19) United States
(12) Patent Application Publication
(10) Pub. No.: US 2005/0019598 A1
(43) Pub. Date: Jan. 27, 2005

(54) Copper-clad laminate

(75) Inventors: Shozo Katsuki, Ube-shi (JP); Hiroto Shimokawa, Ube-shi (JP)

Correspondence Address: NIXON PEABODY, LLP, 401 9TH STREET, NW, SUITE 900, WASHINGTON, DC, 20004-2128, US

(73) Assignee: Ube Industries, Ltd., Ube-shi (JP)

(21) Appl. No.: 10/694,878

(22) Filed: Oct. 29, 2003

(30) Foreign Application Priority Data
Jul. 25, 2003 (JP) 2003-201706

(51) Int. Cl. B32B 15/08

(52) U.S. Cl. 428/626; 428/458

(57) ABSTRACT

A copper-clad laminate is composed of a polyimide film and an electrolytically plated copper film placed on at least one surface side of the polyimide film, in which the copper film has at most 200 protrusions having a diameter of 15 μm or more on its surface not facing the polyimide film, and the laminate has a peel strength of 1 kgf/cm or more and shows a peel strength of 0.6 kgf/cm or more after heating at 150° C. for 24 hours.

### FIELD OF THE INVENTION

This invention relates to a copper-clad laminate, and in particular to a copper clad laminate comprising a polyimide film and a copper film in which the copper film is attached to the polyimide film using neither heat curing adhesive nor thermoplastic adhesive and further the copper film has good surface conditions. The copper-clad laminate of the invention is favorably employable for manufacturing particularly a TAB tape or a flexible printed circuit board (FPC).

### BACKGROUND OF THE INVENTION

Heretofore, the TAB tape and flexible printed circuit board generally have been manufactured by combining a polyimide film with a copper foil using a heat-curing adhesive or a thermoplastic adhesive. Most of the known adhesives are heat resistant only up to a temperature of 200° C. Hence, it cannot be employed in a manufacturing process in which a high temperature procedure such as soldering is involved. Moreover, these adhesives are not satisfactory in their electric performances.

Accordingly, it is desired to provide a copper-clad laminate comprising a polyimide film and a copper film and showing increased heat resistance as a whole. Moreover, there is an additional problem in that a sufficiently thin copper film cannot be placed on the polyimide film by the conventional manufacturing method employing a copper foil and an adhesive. As a result, it becomes difficult to form a fine copper pattern on the polyimide film by etching.

Recently, copper-clad laminates using no adhesive have been proposed. However, it is difficult to manufacture a copper-clad laminate having a high bonding strength (namely, a high peel strength) between the polyimide film and the copper foil, because the polyimide film has a surface of poor adhesiveness. Therefore, a number of trials for improving the adhesiveness of the polyimide film surface have been made. For instance, wet treatment processes such as desmear treatment and an alkali treatment have been known. The wet treatment process is, however, disadvantageous in that a sufficient washing procedure should be done and further a sufficient drying procedure should be done before a copper foil is placed on the wet treated surface. Also known are dry surface treatments such as a plasma discharge treatment and a corona discharge treatment. However, the known dry surface treatments cannot impart to the polyimide film a sufficiently high adhesiveness to the copper foil.

More recently, there has been proposed a copper-clad laminate having a high peel strength between the polyimide film and a copper film which is prepared by subjecting a copolymerized polyimide film or a multi-layered polyimide film to discharge treatment, depositing two metals on the discharge treated surface of the polyimide film by means of a sputtering apparatus, and electrolytically plating the metal deposited surface with copper.

JP-A-6-124,978 and JP-A-6-210,794 both disclose a copper-clad laminate which is prepared by coating a polyimide film (prepared from a biphenyltetracarboxylic dianhydride and p-phenylenediamine) with a polyimide (PMDA polyimide, prepared from pyromellitic dianhydride and 4,4′-diaminodiphenyl ether), heating the coated product to give an intermediate PMDA polyimide layer, and placing a metal-deposited layer and a copper-plated layer on the intermediate layer.

There is further known a copper-clad laminate which is prepared by subjecting a copolymerized polyimide film (prepared by utilizing a combination of pyromellitic dianhydride and 3,3′,4,4′-biphenyltetracarboxylic dianhydride) to glow discharge plasma treatment, depositing a metal layer on the discharge treated polyimide film, and placing a thick copper film on the deposited metal layer by electrolytic metal plating.

It is noted that these heretofore known copper-clad laminate has a high initial peel strength but there are caused troubles in the procedures for manufacturing IC package internal circuits in which the copper-clad laminate is coated with a resist.

### SUMMARY OF THE INVENTION

It is an object of the present invention to provide a copper-clad laminate in which a copper film is combined to a polyimide film using no adhesive, and on which a fine circuit pattern can be formed, and which does not suffer from troubles in the processing stages.

The present inventors have discovered that the above-mentioned troubles of a copper-clad laminate are caused in the case that a large number of abnormally large protrusions are produced on the copper film and that the large number of the abnormally large protrusions are produced by growth of fine copper particles which have been present in a plating solution and deposited on the film. The present invention has been made based on this discovery.

The present invention resides in a copper-clad laminate comprising a polyimide film and an electrolytically plated copper film placed on at least one surface side of the polyimide film, in which the electrolytically plated copper film has at most 200 protrusions having a diameter of 15 μm or more (namely, the abnormally large protrusions) on a surface thereof not facing the polyimide film, and the laminate has a peel strength of 1 kgf/cm (980 N/m) or more and shows a peel strength of 0.6 kgf/cm or more after heating at 150° C. for 24 hours.

The invention further resides in a process for preparing a copper-clad laminate of the invention, comprising the steps of:
preparing a polyimide film having a combination of metal deposited underlying layer and a copper-deposited surface layer at least on one surface thereof; and
placing a copper film on the copper-deposited surface layer by electrolytically plating the surface of the copper-deposited layer by placing the polyimide film vertically in a plating solution.

Preferred embodiments of the invention are described below.

(1) The copper-clad laminate has a continuous laminate having a width of 540 mm or more and the copper film has such uniform thickness in a width direction thereof that the thickness varies within at most ±10% at least in a range of 80% of the width.

(2) The polyimide film has a surface facing the plated copper film, which has protrusions arranged to form a network of protrusions.

(3) The polyimide film is prepared from a biphenyltetracarboxylic compound and a diamine compound comprising 4,4′-diaminodiphenyl ether.

(4) The polyimide film comprises a high heat resistant aromatic polyimide core layer and a flexible aromatic polyimide surface layers, the latter flexible polyimide layers comprises polyimide having a flexible bonding in a molecular structure thereof.

(5) At least two deposited metal layers are placed between the polyimide film and the plated copper film, and the plated copper film and the deposited metal layers have a total thickness in the range of 1 to 20 μm.

(6) The polyimide film has the plated copper layer on one surface side thereof and a heat conductive deposited metal or ceramic layer on another surface side thereof.

(7) The polyimide film has the plated copper layer on both surface side thereof.

(8) The copper-clad laminate shows a peel strength of 0.6 kgf/cm or more after PCT processing which is performed at 121° C. for 168 hours under the conditions of 2 atm. and RH 100%.

(9) The plated copper layer has 0 to 200 protrusions having a diameter of 15 to 1,000 μm.

(10) The plated copper layer has 1 to 200 protrusions having a diameter of more than 15 μm.

(11) The plated copper layer has 0 to 50 protrusions having a diameter of more than 15 μm.

### BRIEF DESCRIPTION OF DRAWINGS

FIG. 1 is a copy of an optical microscope photograph (×100) indicating the conditions on the surface of a copper-clad laminate prepared in Example 4.

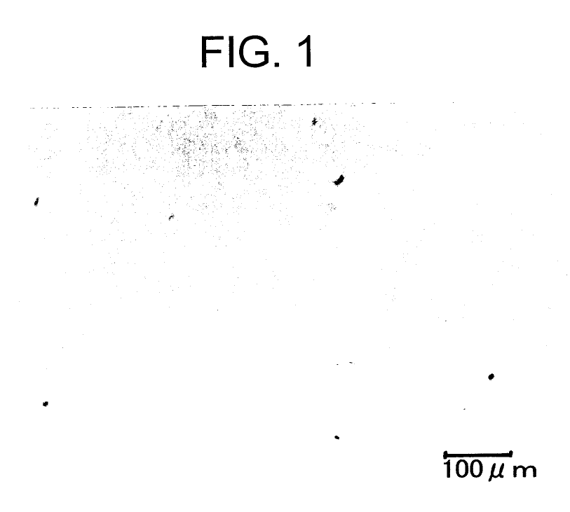

FIG. 2 is a copy of an optical microscope photograph (×100) indicating the conditions on the surface of a copper-clad laminate prepared in Comparison Example 4.

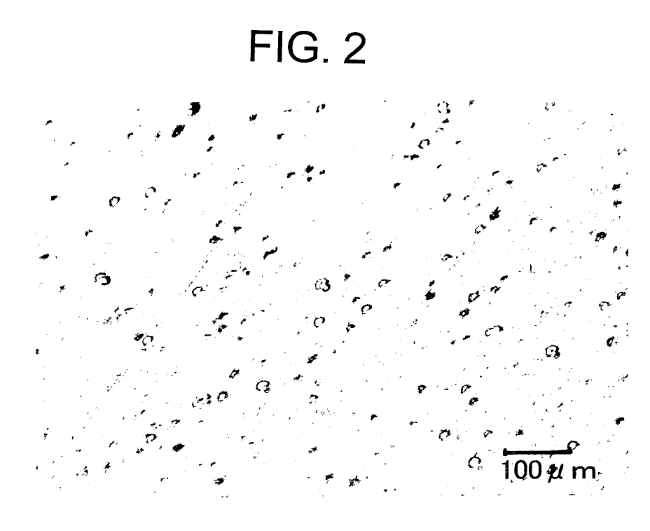

FIG. 3 is a copy of a SEM photograph (×50,000) taken on an aromatic polyimide film in which the protrusions that are produced by plasma processing under reduced pressure are connected with each other in the form of network on the surface layer of the polyimide film.

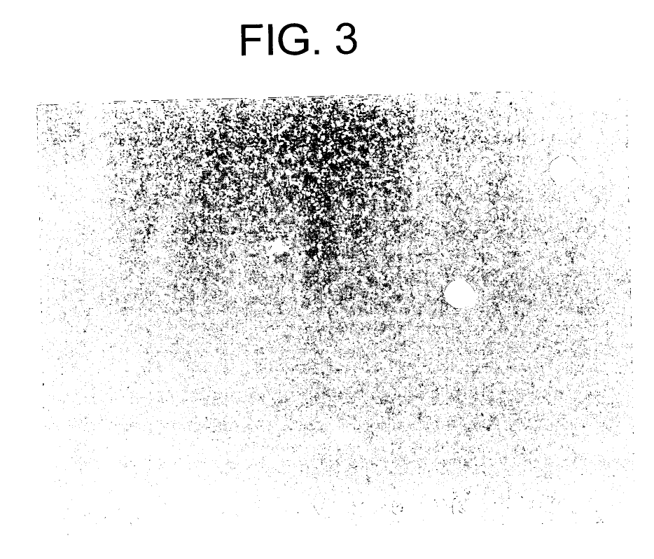

FIG. 4 indicates variation of thickness of the copper film plated on the deposited metal layers on the polyimide layer in Example 4.

### DETAILED DESCRIPTION OF THE INVENTION

The present invention is hereinbelow described in detail by referring to the attached drawings.

According to the further discovery made by the inventors, a copper-clad laminate having a less number of the abnormally large protrusions can be produced by plating a polyimide film under the condition that the polyimide film is placed vertically in an electrolytic plating solution. This means that the surfaces of the polyimide films are vertically arranged with reference to the horizontal surface of the plating solution. If the polyimide film is a continuous film, the continuous film is preferably placed vertically and run keeping the vertical arrangement.

The polyimide film preferably is a multi-layered polyimide film which comprises a highly resistant aromatic polyimide core (i.e., inner) layer comprising polyimide prepared from a biphenyltetracarboxylic acid compound and one or two flexible polyimide surface (i.e., outer) layers comprising polyimide having a bendable bonding in a main chain of its molecular structure. The multi-layered polyimide film is preferably subjected to discharge treatment under reduced pressure to form fine protrusions connected to form a network of protrusions.

Otherwise, the polyimide film is a single layer which comprises polyimide prepared from a combination of a polyamic acid compound (prepared by employing a biphenyltetracarboxylic acid compound) and a polyamic acid compound (prepared by employing a polyamic acid compound having a bendable bonding in a main chain of its molecular structure or a blended polyimide.

The multi-layered polyimide film is preferably prepared by an extrusion process which is performed by the following method.

A polyamic acid solution containing a polyamic acid derived from a biphenyltetracarboxylic acid compound and a polyamic acid solution containing a polyamic acid having a bendable bonding in the main chain are separately extruded, and subsequently placing one on another to form a multi-layered solution product. Each of the polyamic acid solutions preferably has a viscosity of 500 to 5,000 poises. The multi-layered solution product is dried at a temperature of 80 to 200° C., and then cured at a temperature of not lower than 300° C., preferably 300 to 550° C. Thus, the desired multi-layer polyimide film is prepared.

The highly heat resistant polyimide is preferably prepared from not less than 10 mol % (preferably not less than 15 mol %) of a biphenyltetracarboxylic acid compound and not less than 5 mol % (preferably not less than 15 mol %) of p-phenylene diamine, because the resulting polyimide has high heat resistant, high mechanical strength, and high dimensional stability. Other aromatic tetracarboxylic acid compounds such as pyromellitic dianhydride and/or other aromatic diamines such as 4,4-diaminodiphenyl ether can be employed in combination with the biphenyltetracarboxylic acid compound and p-phenylene diamine.

The polyamic acid solutions can be prepared in an organic polar solvent such as an amide solvent (e.g., N,N-dimethylformamide, N,N-dimethylacetamide, N-methyl-2-pyrrolidone, and N-methylcaprolactam), dimethylsulfoxide, hexamethylphosphoramide, dimethylsulfone, tetramethylene-sulfone, dimethyltetramethylenesulfone, pyridine, or ethylene glycol.

The aromatic polyimide having a bendable bonding in the main chain of its molecular structure is preferably prepared from an aromatic tetracarboxylic dianhydride having the formula (1): 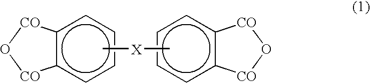
[X is O, CO, S, SO₂, CH₂, or C(CH₃)₂] and/or an aromatic diamine compound having the formula (2): 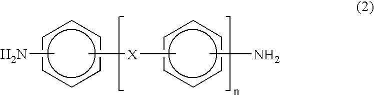
[X is O, CO, S1 SO₂, CH₂, or C(CH₃)₂, and n is an integer of 0 to 4].

In the preparation of the aromatic polyimide having a bendable bonding in the main chain of its molecular structure, other tetracarboxylic acid compounds and/or aromatic amines can be employed in combination.

Examples of the aromatic tetracarboxylic acid compounds having the formula (1) includes aromatic tetracarboxylic acids, their acid anhydrides, their salts and their esters. Most preferred are their acid dianhyrides. Examples of the aromatic tetracarboxylic acids include 3,3′,4,4′-benzophenonetetracarboxylic acid, 2,2-bis(3,4-dicarboxyphenyl)propane, bis(3,4-dicarboxyphenyl)methane, and bis(3,4-dicarboxyphenyl)ether. The aromatic tetracarboxylic acid compounds can be used singly or in combination.

In the case that the aromatic diamine compound having the formula (2) is employed as the diamine compound, the aromatic tetracarboxylic acid compounds can be one or more of a 3,3′,4,4′-biphenyltetracarboxylic acid compound, a 2,3,3′,4′-biphenyltetracarboxylic acid compound, a 2,3,4′,4′-biphenyltetracarboxylic acid compound, and a pyromellitic acid compound. These compounds can be used in combination with the compounds of the formula (1).

Examples of the aromatic diamine compounds having the formula (2) include diphenylether diamines such as 4,4′-diaminodiphenyl ether, 3,3′-diaminodiphenyl ether, benzophenone diamine, 3,3′-diaminobenzophenone, and 4,4′-diaminobenzophenone; diaminodiphenyl alkane diamines such as 3,3′-diaminodiphenylmethane, 4,4′-diaminodiphenylmethane, and 1,3-bis(3-aminophenoxy)benzene; and 4,4′-bis(3-aminophenoxy)biphenyl. These diamine compounds can be employed singly or in combination.

In the case that the compound of the formula (1) is employed as the aromatic tetracarboxylic compound, the diamine compound can be 1,4-diaminobenzene (i.e., p-phenylene diamine), or a benzidine compound such as benzidine or 3,3′-dimethylbenzidine. These diamine compounds can be used singly or in combination. These diamine compounds can be used in combination with the diamine compound of the formula (2).

The extruded multi-layered film preferably has a thickness of 7 to 100 μm, more preferably 7 to 50 μm. In the multi-layered film, the surface polyimide layer preferably has a thickness of 0.1 to 10 μm, more preferably 0.2 to 5 μm.

The polyimide film employed in the invention preferably has fine protrusions arranged and possibly connected to form a network. The protrusions arranged to form a network can be produced on the polyimide film by subjecting the polyimide film to discharge treatment under reduced pressure such as vacuum discharge treatment. The reduced pressure discharge treatment can be performed in the presence of a gas such as He, Ne, Ar, Kr, Xe, N₂, CF₄ or O₂. The gas can be used singly or in combination. The pressure preferably is 0.3 to 50 Pa, more preferably 6 to 27 Pa. The temperature generally is room temperature. According to the experimental trials carried by the inventors, the known atmospheric plasma discharge treatment and corona discharge treatment cannot effectively produced the desired fine protrusions arranged to form a network. The polyimide film having the fine protrusions in the form of a network generally has a surface roughness (Ra: mean roughness) in the range of 0.03 to 0.1 μm, preferably 0.04 to 0.08 μm, that is a width of 0.01 to 1 μm, preferably 0.06 to 0.1 μm, and a length of 0.01 to 1 μm, preferably 0.06 to 0.1 μm. The polyimide film having been subjected to the reduced pressure discharge treatment can be then (namely, successively or after it is once placed under atmospheric conditions) cleaned by a plasma cleaning procedure On the surface of the polyimide film having the fine protrusions, a underlying thin metal layer and an upper thin copper layer are preferably deposited by vacuum deposition or sputtering. Other deposited metal layers can be incorporated. The vacuum deposition can be carried out at a pressure of 10-5 to 1 Pa, and a deposition rate of 5 to 500 nm/sec. The sputtering is preferably carried out by the DC magnet sputtering at a pressure of 0.1 to 1 Pa and a layer deposition rate of 0.05 to 50 nm/sec. The finally deposited layer generally has a thickness of 10 nm to 1 μm and preferably has a thickness of 0.1 to 0.5 μm. The polyimide film can be so processed as to have bores (e.g., through-holes and via-holes) by laser processing, mechanical processing, or wet processing.

The metal deposited layers can be a single layer or plural layers comprising a underlying layer and a surface layer, and an intermediate layer, if desired. The underlying layer preferably comprises chromium, titanium, palladium, zinc, molybdenum, nickel, cobalt, zirconium, iron, nickel-copper alloy, nickel-gold alloy, nickel-molybdenum alloy, or nickel-chromium alloy. The surface layer (or the intermediate layer) preferably comprises copper. The deposited metal layers preferably have a total thickness varying within ±5% by, for instance, adjusting the deposition conditions or cutting the edge portions off from the deposited film. On the deposited two or more metal layers, a copper film is placed by electrolytic plating (i.e., electroplating). The copper film preferably has a thickness of approximately 1 to 20 μm. A non-electrolytic plating can be employed in combination with the electrolytic plating. The non-electrolytic plating is advantageously employed in the case that the metal deposited layers have pin holes. The copper film preferably comprises copper or a copper alloy.

The electrolytic plating is preferably carried out under the condition in that the polyimide film is placed vertically in the plating solution, so that the production of a number of abnormally large protrusions can be effective obviated. If the polyimide film is a continuous film, the continuous polyimide film is placed vertically and moved to run keeping the vertical arrangement in the plating solution.

The plating apparatus can comprise a defatting vessel, an acid-washing vessel, a plural number of plating vessels, a water-washing vessel, a drying stage, and a winding roll.

The plating solution preferably comprises 50 to 200 g/L of copper sulfate, 100 to 250 g/L of sulfuric acid, and a small amount of a brightener. The plating conditions preferably are as follows: a temperature of 15 to 45° C., a current density of 0.1 to 10 A/dm², air agitation, a moving rate of 0.1 to 35 m/min., preferably 0.1 to 5 m/min., addition of appropriate amounts of chlorine and a brightener, and copper negative electrode. The moving rate can be varied by varying the length of a plating bath and number of plating baths.

The metal deposition and copper plating can be made on one surface or both surfaces of the polyimide film. If the metal deposition and copper plating is made on one surface, the other surface can have a heat-conductive metal or ceramic material layer.

The copper-clad laminate of the invention has no or a less number of abnormally large protrusions on its copper film face and further has a high peeling strength between the polyimide film and the copper film not only in the initial sate but also after heating to temperatures required for soldering. Accordingly, the copper-clad laminate is favorably employable for manufacturing an internal circuit in an IC package.

The invention is further described by the following examples.

In the following examples, the physical and chemical characteristics were determined by the methods described below:
Appearance of film surface: observed by taking a SEM photograph (×50,000) for confirming if fine protrusions forming a network are produced.
Number of abnormal protrusions on copper film: A 1 mm×1 mm square area (mm²) on the copper film is observed by an optical microscope (×100) to count number of the abnormal large protrusions (having a diameter of 15 μm or more). The counting procedure is carried out five times (n=5) and their mean value is adopted for evaluation.
Initial peel strength: 900 peel strength of the metal films from the polyimide film which is measured at a rate of 50 mm/min (under the condition described in JIS C6471) on a sample (10 mm width) allowed to stand 24 hours after copper plating.
Heat resistance (after heating at 150° C.): 900 peel strength measured under the above-mentioned conditions after the film is heated to 150° C. for 24 hours, 100 hours, or 168 hours in air.
Heat resistance after PCT: 900 peel strength measured under the above-mentioned conditions after the film is heated to 121° C. for 24 hours or 100 hours at 2 atm., at 100% RH.
Film thickness: The sections of the polyimide core layer and surface layer are measured by means of optical microscope.

### EXAMPLE 1

An aromatic polyamic acid solution (for high heat-resistant polyimide) prepared by reacting p-phenylene diamine and 3,3′,4,4′-biphenyltetracarboxylic dianhydride in a solvent and an aromatic polyamic acid solution (for flexible polyimide) prepared by reacting 4,4′-diaminodiphenyl ether and 3,3′,4,4′-biphenyltetracarboxylic dianhydride were simultaneously extruded separately and immediately combined together to produce a continuous three-layered polyimide film (width: 270 mm) comprising a flexible polyimide surface layer (3 μm), a high heat resistant polyimide core layer (44 μm), and a flexible polyimide surface layer (3 μm).

Thus produced three-layered polyimide film was subjected to the following surface treatments, and then covered with plural metal films.
1) Treatment-1: Etching by Vacuum Plasma Treatment

The polyimide film is placed in a vacuum plasma treating apparatus. The apparatus is evacuated to reach a pressure of lower than 0.1 Pa (inner pressure) and then charged with Ar gas (Ar=100%). Subsequently, the vacuum plasma treatment is carried out at a pressure of 13.3 Pa and a power of 5 KW (40 KHz) for 2 min.
2) Treatment-2: Cleaning of Etched Film Surface

The etched polyimide film is placed in a sputtering apparatus. The apparatus is evacuated to reach an inner pressure of lower than 2×10⁻⁴ and then charged with Ar gas to reach an inner pressure of 0.67 Pa. Subsequently, the electrode attached placed in contact with the polyimide film is applied a high frequency electric power of 13.56 MHz at a power of 300 W for one minute.
3) Formation of Plural Metal Films

On the polyimide film having been subjected to treatment-2 is subsequently deposited 3 nm of Mo thin film, and then 300 nm of Cu thin film by DC-sputtering at 150 W under Ar atmosphere (0.67 Pa). Thus metal-deposited polyimide film is then placed under atmospheric conditions. The metal-deposited polyimide film is then placed vertically in an aqueous plating solution to form a plated cooper film of 5 μm thick, under the following conditions:
copper sulfate concentration: 100 g/L
sulfuric acid: 150 g/L
additives: appropriate amounts of chlorine and a brightener
temperature of plating solution: 23° C.
current density: 1 A/dm² for the first vessel,
   3 A/dm² for the 2nd to 4th vessel
air agitation
electrolytic plating period: 8 min.

### Evaluation

In order to examine problems caused by the presence of abnormal protrusions, a liquid resist (AZ81000DB5, 23 cp, available from Clariant Co., Ltd.) is coated on the copper film of the resulting copper film-coated polyimide (i.e., copper-clad laminate) by a roll coater and then pre-baked at 100° C. for 120 sec. The pre-baked resist layer was observed and checked on the conditions of cissing and unevenness of the coated resist. The results are marked as follows:
AA: excellent (no problems in the resist pattern formation)
BB: good
CC: acceptable
DD: bad (cissing and unevenness are observed)

The results were as follows:
Mean number of abnormal protrusions: 18/mm²
Initial peel strength: 1.2 kgf/cm
Peel strength (heated to 150° C.)
   after 24 hours: 0.7 kgf/cm
   after 100 hours: 0.4 kgf/cm
   after 168 hours: 0.4 kgf/cm
Peel strength (after PCT processing)
   after 24 hours: 0.8 kgf/cm
   after 100 hours: 0.8 kgf/cm
Liquid resist coating
   thickness 1 μm: CC
   thickness 2 μm: BB
   thickness 3 μm: AA
   thickness 4 μm: AA
   thickness 5 μm: AA

### COMPARISON EXAMPLE 1

The procedures of Example 1 were repeated except that the plating was carried out by placing the metal deposited polyimide film horizontally in an aqueous plating solution to produce a copper-clad laminate.

The resulting laminate was evaluated in the same manner as in Example 1. The results are as follows:
Mean number of abnormal protrusions: 250/mm²
Initial peel strength: same as in Example 1
Peel strength (heated to 150° C.): same as in Example 1
Peel strength (after PCT processing): same as in Example 1
Liquid resist coating
   thickness 1 μm: DD
   thickness 2 μm: DD
   thickness 3 μm: CC
   thickness 4 μm: BB
   thickness 5 μm: BB

### EXAMPLE 2

The procedures of Example 1 were repeated except that the plating was carried out at an electrolytic plating period of 4 min. to plate a copper film of 2 μm thick. Thus, a copper-clad laminate according to the invention was produced.

The resulting laminate was evaluated in the same manner as in Example 1. The results are as follows:
Mean number of abnormal protrusions: 15/mm²
Initial peel strength: 1.1 kgf/cm
Peel strength (heated to 150° C.)
   after 24 hours: 0.6 kgf/cm
Peel strength (after PCT processing)
   after 24 hours: 0.7 kgf/cm
   after 100 hours: 0.7 kgf/cm
Liquid resist coating
   thickness 1 μm: CC
   thickness 2 μm: BB
   thickness 3 μm: AA
   thickness 4 μm: AA
   thickness 5 μm: AA

### COMPARISON EXAMPLE 2

The procedures of Example 2 were repeated except that the plating was carried out by placing the metal deposited polyimide film horizontally in an aqueous plating solution to produce a copper-clad laminate.

The resulting laminate was evaluated in the same manner as in Example 1. The results are as follows:
Mean number of abnormal protrusions: 273/mm²
Initial peel strength: same as in Example 2
Peel strength (heated to 150° C.): same as in Example 2
Peel strength (after PCT processing): same as in Example 2
Liquid resist coating
   thickness 1 μm: DD
   thickness 2 μm: DD
   thickness 3 μm: CC
   thickness 4 μm: BB
   thickness 5 μm: BB

### EXAMPLE 3

The procedures of Example 1 were repeated except that the plating was carried out at an electrolytic plating period of 13 min. to plate a copper film of 12 μm thick. Thus, a copper-clad laminate according to the invention was produced.

The resulting laminate was evaluated in the same manner as in Example 1. The results are as follows:
Mean number of abnormal protrusions: 18/mm²
Initial peel strength: 1.3 kgf/cm
Peel strength (heated to 150° C.)
   after 24 hours: 0.7 kgf/cm
   after 100 hours: 0.4 kgf/cm
   after 168 hours: 0.4 kgf/cm
Peel strength (after PCT processing)
   after 24 hours: 0.8 kgf/cm
   after 100 hours: 0.8 kgf/cm
Liquid resist coating
   thickness 1 μm: CC
   thickness 2 μm: BB
   thickness 3 μm: AA
   thickness 4 μm: AA
   thickness 5 μm: AA

### COMPARISON EXAMPLE 3

The procedures of Example 3 were repeated except that the plating was carried out by placing the metal deposited polyimide film horizontally in an aqueous plating solution to produce a copper-clad laminate.

The resulting laminate was evaluated in the same manner as in Example 1. The results are as follows:
Mean number of abnormal protrusions: 350 mm²
Initial peel strength: same as in Example 3
Peel strength (heated to 150° C.): same as in Example 3
Peel strength (after PCT processing): same as in Example 3
Liquid resist coating
   thickness 1 μm: DD
   thickness 2 μm: DD
   thickness 3 μm: DD
   thickness 4 μm: BB
   thickness 5 μm: BB

### EXAMPLE 4

An aromatic polyamic acid solution (for high heat-resistant polyimide) prepared by reacting p-phenylene diamine and 3,3′,4,4′-biphenyltetracarboxylic dianhydride in a solvent and an aromatic polyamic acid solution (for flexible polyimide) prepared by reacting 4,4′-diaminodiphenyl ether and 3,3′,4,4′-biphenyltetracarboxylic dianhydride were simultaneously extruded separately and immediately combined together to produce a continuous three-layered polyimide film (width: 540 mm) comprising a flexible polyimide surface layer (3 μm), a high heat resistant polyimide core layer (44 μm), and a flexible polyimide surface layer (3 μm).

Thus produced three-layered polyimide film was subjected to the following surface treatments, and then covered with plural metal films.

1) Treatment-1: Etching by Vacuum Plasma Treatment

The polyimide film is placed in a vacuum plasma treating apparatus. The apparatus is evacuated to reach a pressure of lower than 0.1 Pa (inner pressure) and then charged with Ar gas (Ar=100%). Subsequently, the vacuum plasma treatment is carried out at a pressure of 13.3 Pa and a power of 11 KW (40 KHz) by running the polyimide film at 1 m/min.

2) Treatment-2: Cleaning of Etched Film Surface

The etched polyimide film is placed in a sputtering apparatus. The apparatus is evacuated to reach an inner pressure of lower than 2×10⁻⁴ and then charged with Ar gas to reach an inner pressure of 0.67 Pa. Subsequently, the electrode placed in contact with the polyimide film running at a rate of 1 m/min. is applied a high frequency electric power of 13.56 MHz at a power of 300 W.

3) Formation of Plural Metal Films

On the continuous polyimide film having been subjected to treatment-2 is subsequently deposited 3 nm of NiCr (80/20, weight ratio) thin film, and then 300 nm of Cu thin film by DC-sputtering under Ar atmosphere (0.67 Pa). Thus metal-deposited polyimide film is then placed under atmospheric conditions. The continuous metal-deposited polyimide film is then run in an aqueous plating solution under the condition that the film was placed vertically and moved keeping the vertical arrangement to form a plated cooper film of 8 μm thick, under the following conditions:
copper sulfate concentration: 100 g/L
sulfuric acid: 150 g/L
additives: appropriate amounts of chlorine and a brightener
temperature of plating solution: 23° C.
current density: 1 A/dm² for the first vessel,
   3 A/dm² for the 2nd to 4th vessel
air agitation
running rate: 0.4 m/min.

### Evaluation

The continuous copper-plated polyimide film was evaluated in the same manner as that in Example 1. The results were as follows:
Mean number of abnormal protrusions: 12/mm²
Initial peel strength: 1.2 kgf/cm
Peel strength (heated to 150° C.)
   after 24 hours: 0.7 kgf/cm
   after 100 hours: 0.4 kgf/cm
   after 168 hours: 0.4 kgf/cm
Peel strength (after PCT processing)
   after 24 hours: 0.8 kgf/cm
   after 100 hours: 0.8 kgf/cm
Liquid resist coating
   thickness 1 μm: CC
   thickness 2 μm: BB
   thickness 3 μm: AA
   thickness 4 μm: AA
   thickness 5 μm: AA

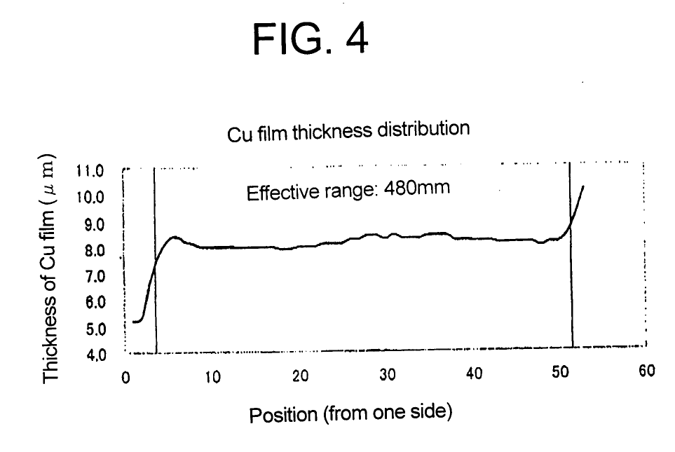

The manufactured copper-clad laminate was measured on variation of the copper film thickness in the width direction for 540 mm (electricity supply area: 30 mm) to determine a ratio of areas having a thickness in the range of 8 μm (pre-set thickness)+10% in the effective width of 480 mm. The results are shown in FIG. 4.

The measuring apparatus was a Fischer scope: MMS-PCB+4 points resistant probe type, RCU (available from Fischer Corporation).

### COMPARISON EXAMPLE 4

The procedures of Example 4 were repeated except that the plating was carried out by placing the continuous metal deposited polyimide film horizontally in an aqueous plating solution and keeping the horizontal arrangement to produce a continuous copper-clad laminate.

The resulting laminate was evaluated in the same manner as in Example 1. The results are as follows:
Mean number of abnormal protrusions: 240/mm²
Initial peel strength: same as in Example 4
Peel strength (heated to 150° C.): same as in Example 4
Peel strength (after PCT processing): same as in Example 4
Liquid resist coating
   thickness 1 μm: DD
   thickness 2 μm: DD
   thickness 3 μm: CC
   thickness 4 μm: BB
   thickness 5 μm: BB

### EXAMPLE 5

The procedures of Example 4 were repeated except that the plating was carried out at a running rate of 3.2 m/min. to plate a copper film of 2 μm thick. Thus, a copper-clad laminate according to the invention was produced.

The resulting laminate was evaluated in the same manner as in Example 4. The results are as follows:
Mean number of abnormal protrusions: 32/mm²
Initial peel strength: 1.1 kgf/cm
Peel strength (heated to 150° C.)
   after 24 hours: 0.6 kgf/cm
Peel strength (after PCT processing)
   after 24 hours: 0.7 kgf/cm
   after 100 hours: 0.7 kgf/cm
Liquid resist coating
   thickness 1 μm: CC
   thickness 2 μm: BB
   thickness 3 μm: AA
   thickness 4 μm: AA
   thickness 5 μm: AA

### COMPARISON EXAMPLE 5

The procedures of Example 5 were repeated except that the plating was carried out by placing the continuous metal deposited polyimide film horizontally and keeping the horizontal arrangement in an aqueous plating solution to produce a copper-clad laminate.

The resulting laminate was evaluated in the same manner as in Example 1. The results are as follows:
Mean number of abnormal protrusions: 252/mm²
Initial peel strength: same as in Example 5
Peel strength (heated to 150° C.): same as in Example 5
Peel strength (after PCT processing): same as in Example 5
Liquid resist coating
   thickness 1 μm: DD
   thickness 2 μm: DD
   thickness 3 μm: CC
   thickness 4 μm: BB
   thickness 5 μm: BB

### EXAMPLE 6

The procedures of Example 4 were repeated except that the plating was carried out at a running rate of 0.3 m/min. to plate a copper film of 12 μm thick. Thus, a continuous copper-clad laminate according to the invention was produced.

The resulting laminate was evaluated in the same manner as in Example 4. The results are as follows:
Mean number of abnormal protrusions: 8/mm²
Initial peel strength: 1.3 kgf/cm
Peel strength (heated to 150° C.)
   after 24 hours: 0.7 kgf/cm
   after 100 hours: 0.4 kgf/cm
   after 168 hours: 0.4 kgf/cm
Peel strength (after PCT processing)
   after 24 hours: 0.8 kgf/cm
   after 100 hours: 0.8 kgf/cm
Liquid resist coating
   thickness 1 μm: CC
   thickness 2 μm: BB
   thickness 3 μm: AA
   thickness 4 μm: AA
   thickness 5 μm: AA

### COMPARISON EXAMPLE 6

The procedures of Example 6 were repeated except that the plating was carried out by placing the continuous metal deposited polyimide film horizontally and keeping the horizontal arrangement in an aqueous plating solution to produce a copper-clad laminate.

The resulting laminate was evaluated in the same manner as in Example 1. The results are as follows:
Mean number of abnormal protrusions: 224/mm²
Initial peel strength: same as in Example 6
Peel strength (heated to 150° C.): same as in Example 6
Peel strength (after PCT processing): same as in Example 6
Liquid resist coating
   thickness 1 μm: DD
   thickness 2 μm: DD
   thickness 3 μm: DD
   thickness 4 μm: BB
   thickness 5 μm: BB

### EXAMPLE 7

The procedures of Example 4 were repeated except that both surfaces of the polyimide film were subjected to the treatment-1 and treatment-2, and that a NiCr thin film (3 nm) and a Cu thin film (300 nm) were deposited on each of both surfaces, to prepare a polyimide film having metal layers on each surface side. Thus treated polyimide film was placed in an electrolytic plating solution, and electrolytically plated under the same conditions as in Example 4.

On each surface side of the polyimide film having metal layers on both sides was plated a copper layer having a thickness of 8 μm. Results of the evaluations according to the procedures set forth in Example 4 were substantially the same as those in Example 4.

1. A copper-clad laminate comprising a polyimide film and an electrolytically plated copper film placed on at least one surface side of the polyimide film, in which the electrolytically plated copper film has at most 200 protrusions having a diameter of 15 μm or more on a surface thereof not facing the polyimide film, and the laminate has a peel strength of 1 kgf/cm or more and shows a peel strength of 0.6 kgf/cm or more after heating at 150° C. for 24 hours.

2. The copper-clad laminate of claim 1, in which the copper-clad laminate has a continuous laminate having a width of 540 mm or more and the copper film has such uniform thickness in a width direction thereof that the thickness varies within at most ±10% at least in a range of 80% of the width.

3. The copper-clad laminate of claim 1, in which the polyimide film has a surface facing the plated copper film, which has protrusions arranged to form a network of protrusions.

4. The copper-clad laminate of claim 1, in which the polyimide film is prepared from a biphenyltetracarboxylic compound and a diamine compound comprising 4,4′-diaminodiphenyl ether.

5. The copper-clad laminate of claim 1, in which the polyimide film comprises a high heat resistant aromatic polyimide core layer and a flexible aromatic polyimide surface layers, the latter flexible polyimide layers comprises polyimide having a flexible bonding in a molecular structure thereof.

6. The copper-clad laminate of claim 1, in which at least two deposited metal layers are placed between the polyimide film and the plated copper film, and the plated copper film and the deposited metal layers have a total thickness in the range of 1 to 20 μm.

7. The copper-clad laminate of claim 1, in which the polyimide film has the plated copper layer on one surface side thereof and a heat conductive deposited metal or ceramic layer on another surface side thereof.

8. The copper-clad laminate of claim 1, in which the polyimide film has the plated copper layer on both surface side thereof.

9. The copper-clad laminate of claim 1, which shows a peel strength of 0.6 kgf/cm or more after PCT processing which is performed at 121° C. for 168 hours under the conditions of 2 atm. and RH 100%.

10. The copper-clad laminate of claim 1, in which the plated copper layer has 0 to 200 protrusions per 1 mm² which have a diameter of 15 to 1,000 μm.

11. The copper-clad laminate of claim 1, in which the plated copper layer has 1 to 200 protrusions per 1 mm² which have a diameter of more than 15 μm.

12. The copper-clad laminate of claim 1, in which the plated copper layer has 0 to 50 protrusions per 1 mm² which have a diameter of more than 15 μm.

13. A process for preparing a copper-clad laminate of claim 1, comprising the steps of:
preparing a polyimide film having a combination of metal deposited underlying layer and a copper-deposited surface layer at least on one surface thereof; and
placing a copper film on the copper-deposited surface layer by electrolytically plating the surface of the copper-deposited layer by placing the polyimide film vertically in a plating solution.
